(19) United States
(12) Patent Application Publication
(10) Pub. No.: US 2018/0150896 A1
(43) Pub. Date: May 31, 2018

(54) METHOD AND SYSTEM FOR RECOMMENDING SKIN CARE PRODUCTS

(71) Applicant: Revieve Oy, Vantaa (FI)

(72) Inventors: Sampo Parkkinen, Vantaa (FI); Gavin Weigh, Helsinki (FI)

(21) Appl. No.: 15/361,095

(22) Filed: Nov. 25, 2016

(51) Int. Cl. G06Q 30/06; G06F 19/00

(52) U.S. Cl. CPC G06Q 30/0631; G06F 19/321

(57) ABSTRACT

Disclosed is a method of recommending one or more skin care products to a user. The method includes receiving one or more images of the user. Further, the method includes receiving indoor environmental data corresponding to an accommodation associated with the user. Moreover, the method includes identifying the one or more skin care products based on each of the one or more images and the indoor environmental data.

### TECHNICAL FIELD

The present disclosure relates generally to a method and a system for making product recommendations; and more specifically, to a method and a system for recommending appropriate skin care product to users.

### BACKGROUND

In humans, skin is the largest organ of the integumentary system. Since the human skin is the outer covering of the body, it is subject to constant attack from various external and internal factors. Therefore, it is important to monitor skin health, and regularly and periodically use skin care products or cosmetics to take care of the skin.

However, there are hundreds of different skin care products and other cosmetics available in the market. Selecting an appropriate skin care product can be difficult and overwhelming for users, as the selection depends on various factors including personal profile information, such as sex, age, skin condition and other characteristics.

Therefore, the users may consult with experts in the area. Often, skin care product advice is a service commonly rendered at skin clinics, gyms, shops, beauty salons and the internet, among other places. However, it may be inconvenient and costly to consult experts every time a decision regarding a skin care product is required to be made.

Therefore, in light of the foregoing discussion, there exists a need to overcome the aforementioned drawbacks.

### SUMMARY

The present disclosure seeks to provide a method of recommending one or more skin care products to a user. Additionally, the present disclosure seeks to provide a method of recommending skin care products based on machine analysis of an image of the user. Moreover, the present disclosure seeks to provide a method of recommending skin care products based on one or more of indoor and outdoor environment of an accommodation of the user. A further object of the present disclosure is to provide a system of recommending one or more skin care products to a user. Moreover, the present disclosure seeks to determine efficacy of skin care products. Further, the present disclosure aims at providing saves in time and money of the users by providing a cheap and efficient solution to select skin care products. In addition, the present disclosure seeks to provide a robust system to recommend skin care products to users.

Accordingly, in one aspect, an embodiment of the present disclosure is a method of recommending at least one skin care product to a user. The method comprises receiving at least one image of a skin of the user; receiving indoor environmental data corresponding to an accommodation associated with the user; and identifying the at least one skin care product based on the at least one image and the indoor environmental data.

In another aspect, an embodiment of the present disclosure is a system for recommending at least one skin care product to a user. The system comprises a user computing device comprising a camera, and a processor. The processor is configured to receive at least one image of a skin of the user from the user computing device; receive indoor environmental data corresponding to an accommodation associated with the user; analyse the at least one image to determine at least one skin characteristic of the user; identify the at least one skin care product based on the at least one skin characteristic and the indoor environmental data; and transmit an indication of the identified at least one skin care product to the user computing device.

Embodiments of the present disclosure substantially eliminate or at least partially address the aforementioned problems in the prior art, and provide a method of recommending one or more skin care products to a user. The users can share their images, i.e. images of their skin, via a computing device, and the images are analysed by a machine to determine one or more skin characteristics of the user. The method recommends one or more skin care products to the user based on the determined skin characteristic(s) and indoor environmental data. The present method and system are based on machine analysis, machine learning and big data, which enables in providing a robust system which is easy to use.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a block diagram of an environment in which a system and a method of the present invention can execute.

FIG. 2 is a flowchart of a method of recommending one or more skin care products to a user.

FIG. 3 is a block diagram of a variation of the environment of FIG. 1, according to some embodiments.

FIG. 4 is a block diagram of another variation of the environment of FIG. 1, according to some embodiments.

FIG. 5 is a block diagram of yet another variation of the environment of FIG. 1, according to some embodiments.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

In one aspect, the present disclosure relates to a method of recommending one or more skin care products to a user. The method comprises receiving at least one image of a skin of the user; receiving indoor environmental data corresponding to an accommodation associated with the user; and identifying the at least one skin care product based on the at least one image and the indoor environmental data.

The accommodation may be one of a home, an office and a vehicle. The communication may be carried out through a wired network or through a wireless network. In other words, the indoor environmental data may be transmitted through a wireless communication channel. For example, the wireless connection may be based on one or more standards from a group including 2G, 3G, 4G, Wi-Fi, Wi-MAX, Bluetooth, GSM, UMTS, LTE-Advanced and Li-Fi standards. The wired connection may be based on one or more of the Public Switched Telephone Network (PSTN), cable, and Ethernet (LAN, MAN, WAN).

The user computing device may be one or more of a workstation, a personal computer, a laptop, a desktop computer, a tablet computer, a smartphone, a wearable computing device or another suitable computing device. The skin care product recommending system may be installed on an online server, such as a cloud server. The indoor automation device may be a home automation system, an office or building automation system, or a car climate control system.

The method includes the skin care product recommending system identifying the one or more skin care products based on each of the one or more images and the indoor environmental data. The skin care product recommending system may identify the one or more skin care products based on the one or more skin characteristics of the user. Further, the skin care product recommending system may identify the one or more skin care products based on the one or more environmental values corresponding to one or more environmental variables associated with the accommodation. Thereafter, the skin care product recommending system may share a list of the one or more identified skin care products with the user. This may further include sharing hyperlinks to an online store for each of the one or more identified skin care products. For example, the hyperlinks may be affiliate links, such that if the user purchases a skin care product using the affiliate links, a certain percentage of the amount spent the user is paid to the owner of the skin care product recommending system. Alternatively, the hyperlinks may point to an online store maintained by the owner of the skin care product recommending system.

According to an embodiment, the method further comprises analysing the at least one image to determine at least one skin characteristic of the user, and the identifying the at least one skin care product is based on the at least one skin characteristic.

According to an embodiment, the indoor environmental data is generated by an automation device installed at the accommodation. In this case, the automation device communicates with the entity carrying out the identification of the skin care product. The communication may be in one way, i.e. the automation device communicates to the entity, or it can be in two ways, i.e. the automation device communicates to the entity and the entity communicates to the automation device.

The indoor environmental data received may comprise one or more environmental values, and thus according to an embodiment, the method further comprises detecting at least one environmental value corresponding to at least one environmental variable associated with the accommodation. For example, the one or more environmental variables may include temperature, humidity and indoor air quality. The indoor air quality may be affected by gases (including carbon monoxide, radon, volatile organic compounds), particulates, microbial contaminants (mould, bacteria), or any other substance that can induce adverse health conditions.

According to a yet further embodiment, the method also comprises receiving outdoor environmental data corresponding to a location of the user, and the identifying of the at least one skin care product is further based on the outdoor environmental data. The outdoor environmental data corresponding to the location of the user may come for example from a weather server or a weather service. The outdoor environmental data may include measurements of one or more variables including, but not limited to, air temperature, relative humidity, barometric pressure, wind speed, wind direction, rainfall, solar flux density, total solar flux, dew point temperature, wet bulb temperature, heat index, wind run, and wind gust. Further, the outdoor environmental data may also include measurements of one or more variables related to pollutants, including, but not limited to PM₁₀, PM_{2.5}, NO₂, SO₂, CO, O₃, NH₃, and Pb. Further, the skin care product recommending system may identify of the one or more skin care products based on the outdoor environmental data.

In another embodiment, the method also provides for evaluation of efficiency of a skin care product, by comparing images of skin of the user before and after treatment with the indicated skin care product. Indeed, according to an embodiment, the at least one image comprises a pre-treatment image obtained prior to using the at least one skin care product and a post-treatment image obtained subsequent to using the at least one skin care product, the method further comprises determining an efficacy of the at least one skin care product based on a comparative analysis between the pre-treatment image and the post-treatment image.

According to an aspect, the present disclosure relates to a system for recommending at least one skin care product to a user. The system comprises a user computing device comprising a camera, and a processor. The processor is configured to receive at least one image of a skin of the user from the user computing device; receive indoor environmental data corresponding to an accommodation associated with the user; analyse the at least one image to determine at least one skin characteristic of the user; identify the at least one skin care product based on the at least one skin characteristic and the indoor environmental data; and transmit an indication of the identified at least one skin care product to the user computing device.

The processor may be arranged at a remote server or it may be arranged at the user device. The choice of location of the processor depends on the amount of data required for the analysis. There may indeed exist various versions of the system and method as described above, depending on the users' needs.

The user may use the user computing device to take the one or more images, or the user device may obtain the images from another source. Thus, according to an embodiment, the user device may comprise a camera.

The user may send the one or more images to the skin care product recommending system. Then, the skin care product recommending system may analyse the one or more images to determine one or more skin characteristics of the user. For example, the one or more skin characteristics may include a radiant complexion, a dull complexion, a rough complexion, a shiny skin, blackheads, pores, red patches, elasticity, visible lines, wrinkles, pimples, blemishes and other imperfections. Further, the user may provide some of skin characteristics to the skin care product recommending system. The skin characteristics provided by the user may include allergies, itchy sensation, burning sensation and sensitivity of the skin.

According to a further embodiment, the system further comprises an automation device installed at the accommodation, the automation device being configured to generate the indoor environmental data and to send it to the processor. The automation device comprises at least one sensor configured to detect at least one environmental value corresponding to at least one environmental variable associated with the accommodation; and at least one controller configured to automatically control at least one environment-modifier based on the at least one environmental value. The at least one environment-modifier comprises at least one of an air conditioner, a heater, a cooler, a humidifier, a de-humidifier, an air-ionizer and a light source.

According to an embodiment, the user computing device is configured to communicate with the automation device. The communication may take place via a wired or wireless network, as discussed above.

In addition to recommending skin care products, the skin care product recommending system may recommend using devices to modify the indoor environment. The devices may include humidification systems, cooling towers, air purifiers, air conditioners, heaters, de-humidifiers, air-ionizers and light sources. In case such devices are incorporated with the automation device, the system may automatically instruct the automation system to use such a device.

According to an embodiment, the processor is further configured to receive outdoor environmental data corresponding to a location of the user, and the processor is configured to identify the at least one skin care product further based on the outdoor environmental data.

According to yet another embodiment, the at least one image comprises a pre-treatment image obtained prior to using the at least one skin care product and a post-treatment image obtained subsequent to using the at least one skin care product, and the processor is configured to determine an efficacy of the at least one skin care product based on a comparative analysis between the pre-treatment image and the post-treatment image.

Based on the one or more skin characteristics, the skin care product recommending system may determine a type of the skin. The type of skin may be one of a normal skin type, a dry skin, an oily skin type, a sensitive skin and a combination skin type. The normal skin type corresponds to skin with perfect balance of moisture content and production of oil. The normal skin type may be detected if the one or more skin characteristics include a few imperfections, barely visible pores, and a radiant complexion. The dry skin type corresponds to dry and flaky skin. The dry skin may be detected if the one or more skin characteristics include dull complexion, redness and visible lines. The oily skin type corresponds to greasy and shiny skin. The oily skin may be detected if the one or more skin characteristics include enlarged pores, shiny complexion, blackheads and pimples. The sensitive skin type corresponds to the most delicate skin. The sensitive skin may be detected if the one or more skin characteristics include redness, burning and dryness. The combination skin type corresponds to two or more different skin types. This is the most common skin type. The combination skin may be detected if the one or more skin characteristics include large pores, blackheads and shiny skin.

According to yet another embodiment, the system may include a main server hosting product information and brand information and other relevant attributes of multiple skin care products. Further, the main server may host an online shop for the user to select and order skin care products. For example, the user may use the user computing device, such as a smartphone, to browse the online shop. The system may also include a second server system for providing outdoor environmental data, such as local weather and weather forecast corresponding to the location of the user. Moreover, the system may include a building automation system for obtaining indoor environmental data related to home or workplace of the user. The main server may be configured to receive one or more images of the skin of the user via the user computing device, the indoor environmental data via the building automation system and the outdoor environmental data from the second server. Thereafter, the main server may be configured to recommend one or more skin care products of the multiple skin care products, based on one or more of the one or more images of the skin of the user, the indoor environmental data and the outdoor environmental data.

According to an embodiment, the present method and system may also use a set of filters to find an appropriate product from a large catalogue of skin care products. The system may indeed include a skin care product recommending system using a first filter based on machine analysis of an image of the skin of the user to obtain a first list of skin care products from the catalogue of skin care products. Next, the skin care product recommending system may use a second filter based on outdoor environmental data to obtain a second list of skin care products from the first list of skin care products. Then, the skin care product recommending system may use a third filter based on indoor environmental data received from an indoor automation device to obtain a third list of skin care products from the second list of skin care products. The third list of skin care products may be shared with the user as a recommended list of skin care products. The user may then purchase and use one or more products from the third list. Finally, a feedback loop allows the user to provide a post-treatment image to the skin care product recommending system to determine effectiveness of a recommended skin care product.

In an example, the skin care product recommending system (or the product server) may include a list of 100000 different skin care products with various attributes. The user may visit an online portal or use a software application (example, a smartphone application) to access the skin care product recommending system and provide personal information such as name, sex, age, location and even known allergies. The skin care product recommending system may use the personal information to filter the list of skin care products to a selection to 10000 skin care products. Next, the user may send a pre-treatment image to the online portal. A machine analysis of image of the user may be used to filter the list of skin care products to a selection to 1000 skin care products. The skin care product recommending system may then access a second server (the weather server) to obtain information about the local weather and weather trends at the location of the user. Then, the skin care product recommending system may further filter the list of skin care products based on the weather to a selection to 100 skin care products. For example, if the location is in a place with cold air outside, the list is different, than, if the place is hot and humid. Thereafter, the skin care product recommending system may access the indoor automation device to obtain indoor environment data at the accommodation. Then, the list of skin care products may be further filtered down to a selection to 10 skin care products based on the indoor environment data. This list may be shared with the user as a recommended list of skin care products. The user may the purchase one or more of the 10 skin care products in the recommended list. Finally, the user may send post-treatment image to the skin care product recommending system for the system to learn if the one or more of the 10 skin care products were effective.

Further, according to an embodiment, the system and method may comprise using a list of skin care products purchased by the user within the preceding 6 or 12 month period, and using this list as the basis for choosing the recommended product. Information about the purchased skin care products can be obtained for example from the purchase actions carried out on the internet, or the user may manually enter the data to the system. The system may further be configured to alert the user when a skin care product is presumed to soon run out (based on the number of recommendations in the past, the amount of product estimated to have been used at each time, and the size of the product container, for example), or when a particular skin care product package has presumably been open for a period exceeding the recommended time of use (or when such time of use will soon expire). Such a system would allow the user to re-purchase his or her preferred products in time, without risking of being run out of them.

Still further, the system and method may take into account a predicted weather forecast. For example, the processor may be configured to receive regular weather forecasts from a weather forecast server, and to take this into account in the recommendation of the skin care product. For example, if the weather forecast predicts a significant drop in temperature, the system may instruct the user to prepare his or her skin to the upcoming change of temperature. Similarly, the user may enter to the system data of an upcoming travel, for example the location of the upcoming travel and/or the estimated duration of travel (such as flight time). Again, this would allow the system to recommend to the user appropriate skin products to either use beforehand to prepare the skin or the kind of skin products the user would need to take with him or her to the trip.

The system may also include a memory which may be operably connected to the processor. The memory may be configured to store one or more of computer instructions and data. The computer instructions may correspond to the method explained in detail above, such that when the computer instructions are executed by the processor, the method is executed. The data may include, but is not limited to, a product catalogue corresponding to the skin care products, personal user information and credentials to access the automation device, a product server and a weather server.

In a further embodiment, the system may be configured to maintain a big data database. For example, the big data database may be stored in the memory. The big data database may include data for multiple skin care products, including, their names, description, reviews, price, deals, availability, and efficacy based on a comparative analysis between a pre-treatment image, obtained prior to using a skin care product and a post-treatment image, obtained subsequent to using the skin care product. Further, the big data database may include data about the users, automation systems, weather information providers, environment-modifier devices, and usage advice. Further, the system may be configured to use machine learning techniques in conjunction with the big data database. The machine learning enables the system to adapt and improve as users use the system over a period of time.

In addition to recommending skin care products, the skin care product recommending system may also provide advice to the user to take care of their skin. The advice may include avoid over cleansing your skin, avoid using too cold or hot water, use mild soaps and body washes, avoid direct sunlight, user a broad spectrum sunscreen, wash your skin gently, never wear makeup to bed, buy clothing for sensitive skin, intake a good diet, stay hydrated, moisturize often, avoid smoking, consult a doctor or a dermatologist.

The embodiments listed above for the method apply also to the present system and vice versa.

### Detailed Description of the Drawings

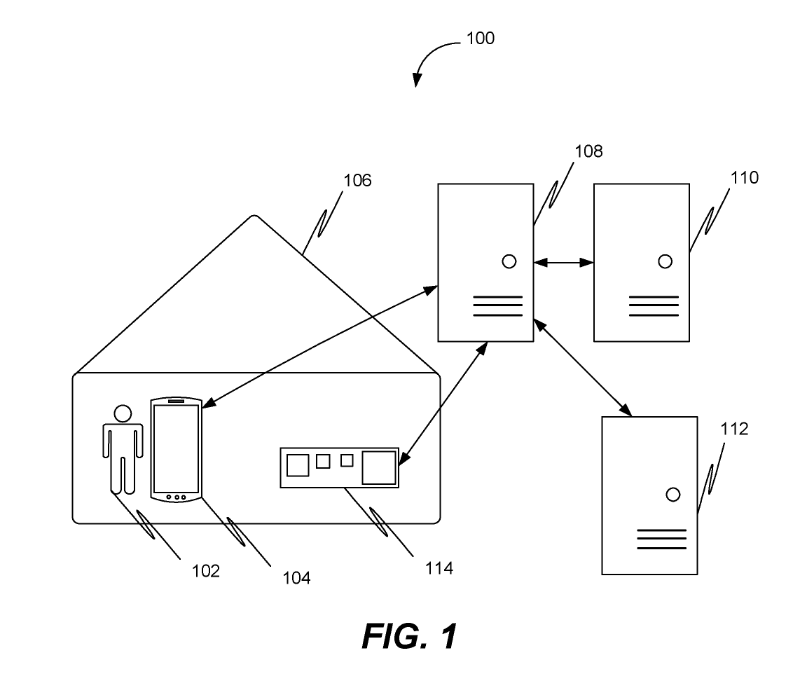

FIG. 1 is a schematic block diagram of an environment 100 in which a system and a method of the present invention can be executed. The environment 100 includes a user 102 with a user computing device 104 in an accommodation 106. The user may use the user computing 104 device to send a request to a skin care product recommending system 108. The skin care product recommending system 108 may receive weather information from a weather server 110 and product information from a product server 112. Further, the skin care product recommending system 108 receives indoor environmental data, for example from an indoor automation device 114 installed in the accommodation 106.

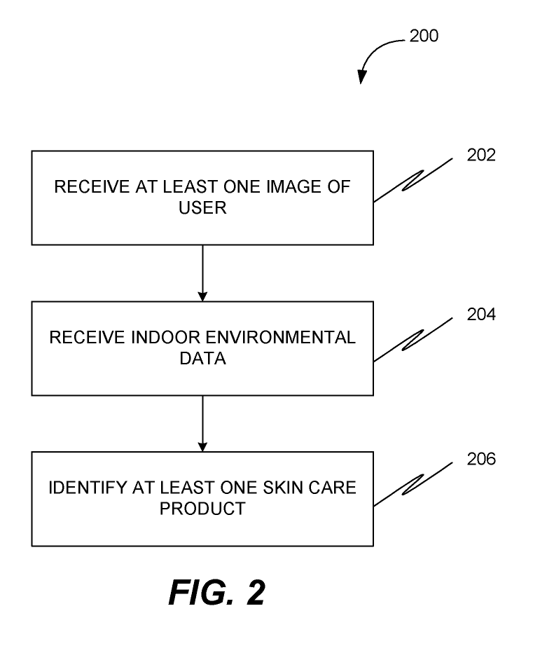

FIG. 2 is a flowchart for a method 200 of recommending one or more skin care products to the user according to an embodiment. At 202, the method 200 includes receiving one or more images of the skin of the user. Next, at 204, the method 200 includes receiving indoor environmental data corresponding to the accommodation associated with the user at the skin care product recommending system. Finally, at 206, the method includes the skin care product recommending system identifying the one or more skin care products based on each of the one or more images and the indoor environmental data.

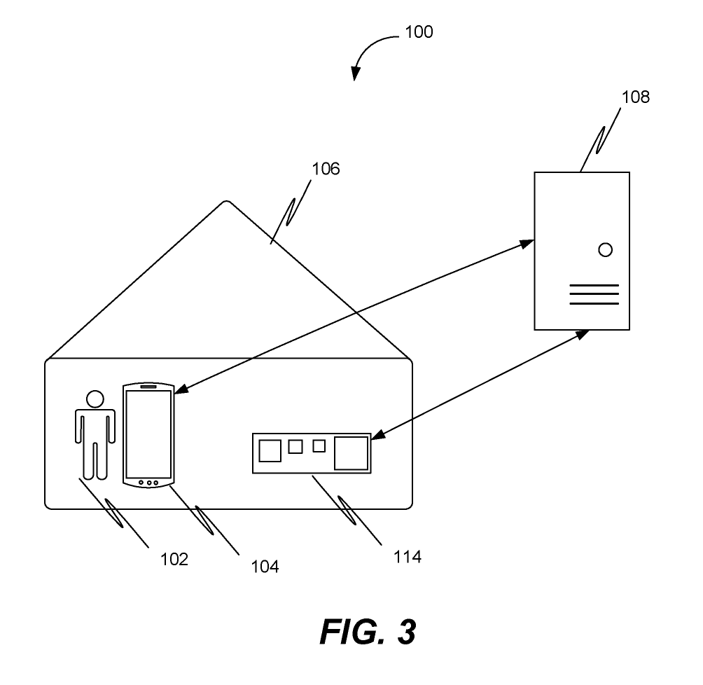

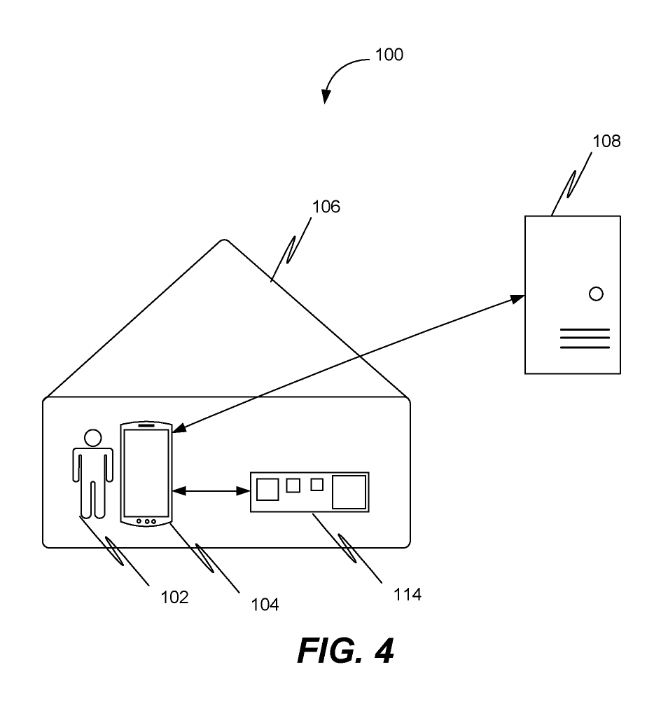

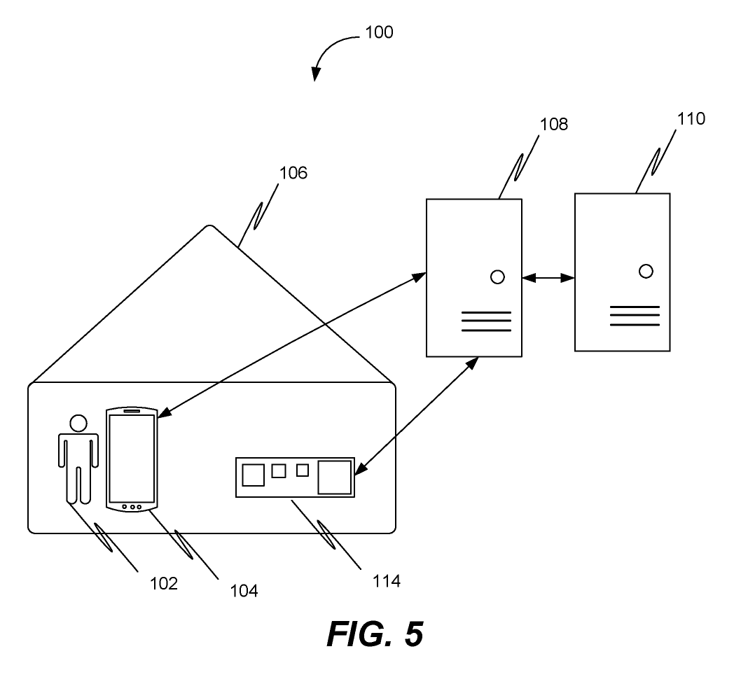

Some further embodiments are shown in FIGS. 3, 4 and 5. Indeed, in an embodiment, the skin care product recommending system 108 may have a direct communication connection with the indoor automation device 114, as shown in FIG. 3. Therefore, in this embodiment, the skin care product recommending system 108 receives the indoor environmental data directly from the indoor automation device 114. In an alternate embodiment, the skin care product recommending system 108 may have a communication connection with the user computing device 104, which is in direct communication with the indoor automation device 114, as shown in FIG. 4. Therefore, the skin care product recommending system 108 may receive the indoor environmental data indirectly from the user computing device 104, which receives the indoor environmental data from the indoor automation device 114. In yet another embodiment, the product server 112 may be incorporated in the skin care product recommending system 108, as shown in FIG. 5.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A method of recommending at least one skin care product to a user, the method comprising
receiving at least one image of a skin of the user;
receiving indoor environmental data corresponding to an accommodation associated with the user; and
identifying the at least one skin care product based on the at least one image and the indoor environmental data.

2. A method according to claim 1, further comprising analysing the at least one image to determine at least one skin characteristic of the user, wherein the identifying the at least one skin care product is based on the at least one skin characteristic.

3. A method according to claim 1, wherein the indoor environmental data is generated by an automation device installed at the accommodation.

4. A method according to claim 1, further comprising detecting at least one environmental value corresponding to at least one environmental variable associated with the accommodation.

5. A method according to claim 1, wherein the indoor environmental data is transmitted through a wireless communication channel.

6. A method according to claim 1, further comprising receiving outdoor environmental data corresponding to a location of the user, wherein the identifying of the at least one skin care product is further based on the outdoor environmental data.

7. A method according to claim 1, wherein the at least one image comprises a pre-treatment image obtained prior to using the at least one skin care product and a post-treatment image obtained subsequent to using the at least one skin care product, and the method further comprises determining an efficacy of the at least one skin care product based on a comparative analysis between the pre-treatment image and the post-treatment image.

8. The method according to claim 1, wherein the accommodation is one of a home, an office and a vehicle.

9. A system for recommending at least one skin care product to a user, the system comprising
a user computing device, and
a processor configured to
receive at least one image of a skin of the user from the user computing device;
receive indoor environmental data corresponding to an accommodation associated with the user;
analyse the at least one image to determine at least one skin characteristic of the user;
identify the at least one skin care product based on the at least one skin characteristic and the indoor environmental data; and
transmit an indication of the identified at least one skin care product to the user computing device.

10. The system according to claim 9, further comprising an automation device installed at the accommodation, the automation device being configured to generate the indoor environmental data and to send it to the processor, the automation device comprising
at least one sensor configured to detect at least one environmental value corresponding to at least one environmental variable associated with the accommodation; and
at least one controller configured to automatically control at least one environment-modifier based on the at least one environmental value,
wherein the at least one environment-modifier comprises at least one of an air conditioner, a heater, a cooler, a humidifier, a de-humidifier, an air-ionizer and a light source.

11. A system according to claim 10, wherein the user computing device is configured to communicate with the automation device.

12. A system according to claim 9, wherein the processor is further configured to receive outdoor environmental data corresponding to a location of the user, and the processor is configured to identify the at least one skin care product further based on the outdoor environmental data.

13. A system according to claim 9, wherein the at least one image comprises a pre-treatment image obtained prior to using the at least one skin care product and a post-treatment image obtained subsequent to using the at least one skin care product, and the processor is configured to determine an efficacy of the at least one skin care product based on a comparative analysis between the pre-treatment image and the post-treatment image.

14. A system according to claim 9, wherein the processor is arranged at the user device.

15. A system according to claim 9, wherein the user device comprises a camera.
